(19) United States
(12) Patent Application Publication
(10) Pub. No.: US 2002/0172454 A1
(43) Pub. Date: Nov. 21, 2002

(54) Reconfigurable optical add/drop module

(75) Inventor: Tallis Y. Chang, Northridge, CA (US)

Correspondence Address: HOGAN & HARTSON L.L.P., 500 S. GRAND AVENUE, SUITE 1900, LOS ANGELES, CA, 90071-2611, US

(73) Assignee: Chromux Technologies, Inc.

(21) Appl. No.: 09/859,124

(22) Filed: May 15, 2001

(51) Int. Cl. G02B 6/28

(52) U.S. Cl. 385/24; 385/18

(57) ABSTRACT

An optical add/drop module includes an add channel, an input channel, a drop channel and an output channel, with each channel aligned to transmit or receive light reflected from a common mirror in at least one state of the add/drop module. Rotating the mirror changes the state of the module. In the module's add/drop state, light from the input channel reflects from the mirror into the drop channel and light from the add channel reflects off the mirror to the output channel. In the module's pass through state, light from the input channel reflects off the mirror into the output channel and light from the add channel reflects off the mirror to a position other than the drop channel. Arrays of add, input, drop and output channels can be coupled to a linear array of independent micro-electromechanical mirrors to provide an integrated set of optical add/drop modules.

### BACKGROUND OF THE INVENTION

1. Field of the Invention

The present invention relates to optical components and, in particular, to optical components capable of directing at least one optical channel and performing add or drop functions for optical channels.

2. Description of the Related Art

Optical networks have become prevalent for long distance communication, including for the backbone of the Internet. Demand for additional bandwidth in short haul (i.e., metro) and long haul optical networks continues to grow and a variety of different strategies have been adopted to improve the utilization of the bandwidth within existing optical fiber networks. There is, for example, increasing utilization of multiple wavelength or broad-spectrum light communication over optical fiber links, generally using the technology known as wavelength division multiplexing (“WDM”). Presently the most common implementation of WDM communication uses a plurality of different lasers as light sources, with each laser emitting light at a wavelength different from the wavelengths emitted by the other lasers in the system. Each of the different wavelengths of light represents a different, substantially independent communication channel and symbols can be transmitted on each of these different communication channels using a modulation and encoding function appropriate to the channel. For example, each of the channels might be modulated and encoded using time domain techniques.

Optical networks use a variety of components, including add/drop modules, optical multiplexers and optical switches. Generally these components are bulky, expensive and have low levels of integration. The lack of adequate, reliable and cost-effective components has retarded the implementation of optical networks and has limited optical networks to very high traffic systems.

An example of such a component, an optical add/drop module, is illustrated in FIG. 1. The illustrated add/drop module 10 includes an input fiber 12, a first optical circulator 14 providing a connection to a drop channel fiber 16 and coupling the input light to a fiber Bragg grating 18. The fiber Bragg grating selects the channel (by its characteristic wavelength) to be dropped by reflection back through the optical circulator 14 and into the drop channel fiber 16. Up to N channels of light are provided to the input optical circulator 14 and, in the illustration, a single channel of light at a preselected wavelength may selectively be removed from the input light signal. A second optical circulator 20 is coupled to the output of the fiber Bragg grating 18 and includes an add port coupled to the add channel fiber 22. Light may selectively be input through the add channel fiber 22 to couple a signal channel into the system to replace the channel dropped by reflection from the fiber Bragg grating into the drop fiber. The wavelength of the fiber Bragg filter controls which channel is dropped and added at the module. Other channels pass through this single channel add/drop module. Light output from the illustrated module is provided to output fiber 24 and includes N channels, with the i-th of those channels replaced by a new signal. Add/drop modules do not always perform both add and drop functions and may instead simply drop a channel or simply add a channel, without replacing or removing a corresponding channel in the output or input signals.

The FIG. 1 add/drop module is made up of well known optical components. Optical circulators are multiport devices that receive signals at ports and provide the received signals to designated output ports. Optical circulators may, for example, be based on Faraday rotators and are commercially available. Light input to the optical circulator 14 is provided to the output fiber 26 connected to the fiber Bragg grating 18. Light reflected back from the fiber Bragg grating 18 through the fiber 26 to the circulator is, in this illustration, circulated and output through the drop channel fiber 16. Different routings are achieved by choosing different configurations of optical circulators; optical circulators are passive in nature.

The FIG. 1 add/drop module also includes a fiber Bragg grating that acts as a filter in a reflection mode to selectively reflect a single wavelength channel from an input broadband (WDM) light signal. Fiber Bragg gratings can be formed by creating an optical modulation pattern in a light sensitive fiber by exposing the light sensitive fiber with a desired pattern. Fiber Bragg gratings are commercially available in wavelength ranges that match the wavelengths of generally available laser light sources. When a fixed fiber Bragg grating, which always filters a characteristic wavelength of light, is used in the add/drop module of FIG. 1, the module always drops and adds the predetermined channel of light. Such a configuration is quite limited in its utility.

A tunable fiber Bragg grating 18 might alternately be used in the FIG. 1 add/drop module. For example, fiber Bragg gratings can be tuned mechanically by stretching the fiber to alter the spacing within the grating. A stretched tunable fiber grating generally has a new characteristic filtering wavelength at which it reflects and no longer effectively reflects the specific wavelength associated with the unstretched fiber Bragg grating and will then pass that wavelength. Sufficient tuning of the fiber Bragg grating can be achieved through an elastic deformation of the fiber grating. The resulting tunable implementation of the FIG. 1 add/drop module is reconfigurable to add and drop different single wavelengths.

The FIG. 1 optical add/drop module 10 is capable of adding and/or dropping a single channel of light. Wavelength division multiplexing (WDM) transmits N signal channels, for example, on N corresponding wavelength channels. For such a system, it is desirable to be able to drop and add any of the N channels. FIG. 2 shows a four channel add/drop module appropriate for a communication network having four or more channels. Four Bragg grating filters 28, 30, 32, 34 are adapted to reflect different wavelengths of light, so that each has a characteristic wavelength corresponding to a different one of the four channels of the communication network. Up to four channels of light to be dropped are reflected back through the circulator, through the drop channel fiber and into a demultiplexer 36, which separates the dropped signals into individual channels for detection. Similarly, up to four channels of light may be introduced into an optical multiplexer 38 that combines the light onto a single fiber and provides it to the circulator 20. The optical demultiplexer 36 and optical multiplexer 38 illustrated in FIG. 3 include arrayed waveguide gratings formed on silicon or silica substrates and are commercially available. The added light reflects off of the respective fiber Bragg gratings, through the circulator 20 and out the output fiber 24. Generally in the configuration of FIG. 2, each of the fiber Bragg gratings 28, 30, 32, 34 is tunable to allow the selective adding and dropping of each of four channels within the illustrated system.

The add/drop modules of FIG. 1 and of FIG. 2 are limited in that they are either not tunable or, when tunable, are subject to aging effects and do not switch rapidly. Efforts to improve on the tunable fiber Bragg gratings include attempts to form microelectromechanical (MEM) systems that provide 2×2 and other types of optical switches. Microelectromechanical systems include devices such as gyroscopes and mirror arrays formed on the surface of semiconductor substrates. In essence, these are very small mechanical devices formed on the surface of semiconductor substrates using semiconductor fabrication technology, including photolithography, thin film deposition, etching, and impurity doping by diffusion and ion-implantation. Microelectromechanical systems often include moving parts that are released from the underlying substrate and can move independently of the substrate.

An illustration of a 2×2 add/drop switch formed on a silicon on insulator (SOI) substrate is shown in C. Marxer, et al., “Vertical Mirrors Fabricated by Deep Reactive Ion Etching for Fiber-Optic Switching Applications,” IEEE/ASME Journal of Microelectromechanical Systems, Vol. 6, No. 3, pp. Sept. 1997. This switch is illustrated schematically in FIGS. 3 and 4. Four optical fibers are held in fixed relation so that an input and output fiber are aligned end to end and an add and a drop fiber are aligned end to end. A mirror 40 is provided so that it can be translated between the ends of the fibers by an MEM comb electrode structure 42. In the state illustrated in FIG. 3, the mirror is positioned so that light from the add fiber is provided to the output fiber and light from the input fiber 44 is provided to the drop channel fiber 46. Note that the ends of the fibers are tapered to allow the fibers to be brought into closer relation to one another.

In the FIG. 4 position, the mirror is withdrawn from between the fibers by the electrode structure 42. Light from the input fiber is provided to the output fiber. Also note that light from the add channel, when present, is provided to the drop channel fiber in this configuration. In the add/drop mode, the channel from the input to be dropped is output through the drop port and the signal provided at the add port replaces the dropped channel in the light signal output from the module. In the pass through mode, the input signal passes through without filtering and is output from the module. Also in this pass through mode, the signal from the add channel is coupled to the drop port. The two modes of the switch are illustrated in FIG. 5.

Typically the dropped channel from the input fiber 44 (FIG. 3) reflects from the mirror 40 and is provided through the drop fiber 46 to a detector that detects the optical signal and outputs and an electrical signal. In the pass through mode of the add/drop module of FIGS. 3 & 4, there is a direct connection between the add and the drop channels. The signal from the add channel received by the detector attached to the drop fiber has a much larger magnitude than the dropped signal that is normally provided to the detector. This is because the reflected signal of the dropped channel is attenuated by propagating over a long length of fiber and by the reflection to a greater extent than the add channel that is generated or amplified at the add fiber. Because the detector is designed to accommodate the lower amplitude drop channel light, the detector may saturate for the greater magnitude of the add channel light. This configuration is undesirable in many instances.

Arrays of the 2×2 switches of FIGS. 3 & 4 can be combined with a demultiplexer and a multiplexer to provide a multichannel optical switch. Such switches are complicated, bulky and expensive. Such a switch is illustrated schematically in FIG. 6, although other configurations are known. An input fiber, for example carrying up to four channels of optical signals, provides its signals to a demultiplexer 48. The demultiplexer 48 may include an arrayed waveguide to separate optical signals modulated on different wavelength optical channels. The four channels are output through fiber or waveguide lines to a set of four 2×2 switches 50 as illustrated in FIGS. 3 and 4. Each of the 2×2 waveguides is provided with an input add signal on an add fiber and a drop channel so that each wavelength of light can be dropped and replaced. The outputs from the switches is input to the multiplexer 52, which recombines the four separated wavelength channels and provides the signals on the output fiber. Multiplexer 52 may also be an arrayed waveguide grating.

Assembling the structure of FIG. 6 requires extensive handwork and the resulting switch is expensive.

### SUMMARY OF THE PREFERRED EMBODIMENTS

According to an aspect of the present invention, an optical system includes a switching mirror defining a first switch state and a second switch state. The system includes an input port positioned to provide input light to the switching mirror and an add port positioned to provide add light to the switching mirror. An output port is positioned to receive the input light from the switching mirror in the first switch state and to receive the add light from the switching mirror in the second switch state. A drop port is positioned to receive the input light from the switching mirror in the second switch state.

According to another embodiment of the present invention, an optical system includes an array of independent switching mirrors, with each of the switching mirrors defining a first switch state and a second switch state. An array of input ports is each positioned to provide input light to a respective one of the switching mirrors. Each of an array of add ports is positioned to provide add light to a respective one of the switching mirrors. Each of an array of output ports is associated with a respective switching mirror and is positioned to receive the input light from the respective switching mirror in the first switch state and to receive the add light from the respective switching mirror in the second switch state. Each of an array of drop ports is associated with a respective switching mirror and positioned to receive the input light from the switching mirror in the second switch state.

### BRIEF DESCRIPTION OF THE DRAWINGS

Aspects and various advantages of the present invention are described below, with reference to the various views of the drawings, which form a part of this disclosure.

FIG. 1 shows a conventional, single channel, optical add/drop module.

FIG. 2 illustrates a four channel add/drop module.

FIGS. 3 & 4 illustrate a 2×2 optical switch made using microelectromechanical (MEM) structures.

FIG. 5 illustrates the pass through and add/drop states of the 2×2 add/drop switch of FIGS. 3 &4.

FIG. 6 illustrates a four channel add/drop module using 2×2 optical switches.

FIGS. 7 and 8 show an add/drop state and a pass through state for a 2×2′ switch in accordance with a preferred embodiment of the present invention.

FIG. 9 shows schematically the two states of the 2×2′ switch of FIGS. 7 and 8.

FIG. 10 shows a more detailed implementation of a 2×2′ switch in accordance with preferred aspects of the present invention.

FIG. 11 shows arrays of add, input, drop and output ports like those of FIG. 10 integrated with an array of independent microelectromechanical mirrors to provide eight channels of 2×2′ switches.

FIG. 12 illustrates schematically an exemplary MEM mirror configuration.

FIG. 13 shows an integrated N-channel switch in accordance with preferred aspects of the present invention

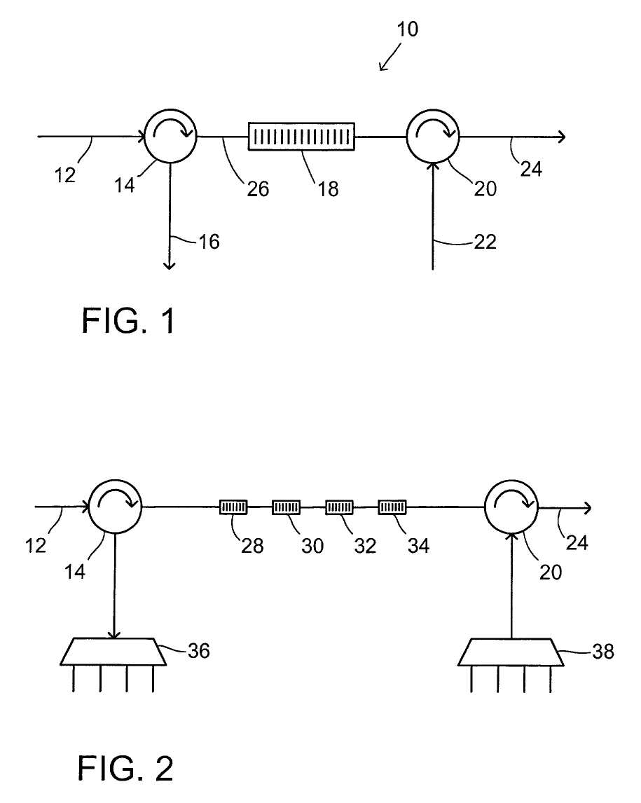

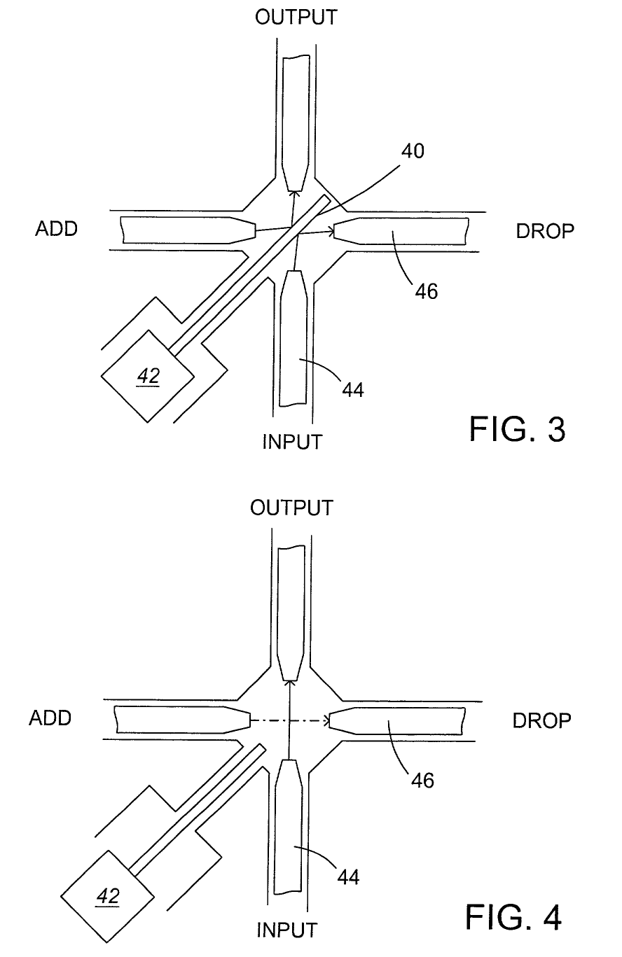

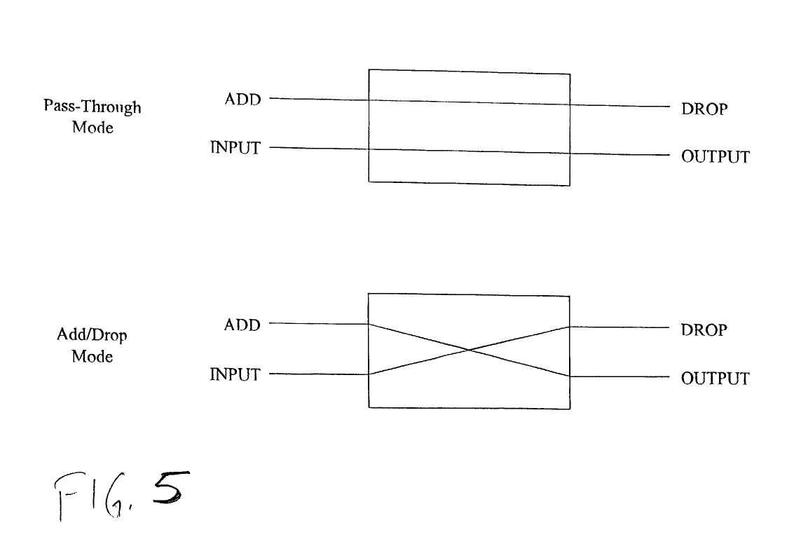

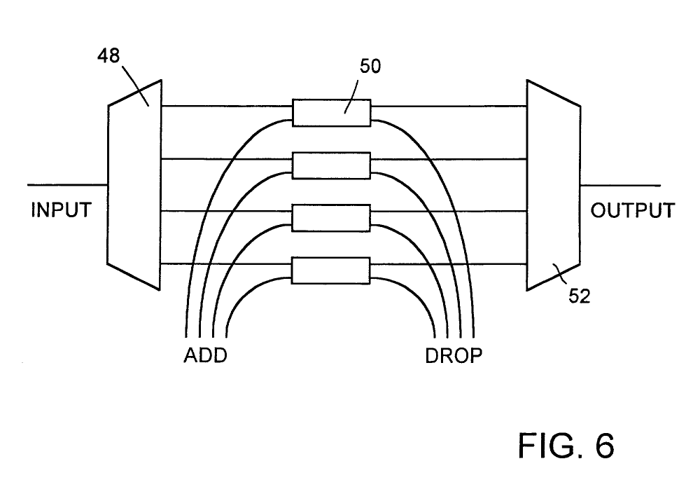

### DETAILED DESCRIPTION OF THE PREFERRED EMBODIMENTS

An aspect of the present invention provides an optical switch, such as an add/drop module, in which the module changes between states by rotating or translating a mirror between a pass through position and an add/drop position. In the add/drop mirror position, an input channel is coupled to a drop channel and an output channel is coupled to receive a signal from the add channel. In the pass through mirror position, the input channel is coupled to the output channel and the add channel and the drop channels are preferably not coupled together. In a particularly preferred implementation of the invention, add, input, drop and output ports are positioned in a plane and a mirror is rotated or translated to selectively couple light between desired ones of the ports. For example, in the pass through position, light from the input port reflects off of the mirror and is received by the output port. In this state light from the add port reflected off the mirror preferably is not incident on the drop or output ports. Following this example for the mirror positioned in the add/drop state for the module, light from the input port is coupled to the drop port and light from the add port is coupled to the output port. The state of the module is changed by, for example, rotating the mirror from its first position to its second position.

Aspects of the present invention take advantage of microelectromechanical technology to provide integrated optical components. In particular, aspects of the present invention provide the mirror as a microelectromechanical element so that the assembly as a whole can be highly integrated, for example on a silicon or silica substrate. In such a highly integrated device, the various ports for the optical add/drop module can be formed on the same substrate as the mirror. On the other hand, a different type of integration might be adopted to emphasize including a plurality of channels within a single switching array. In such an alternate form of integration, illustrated and discussed below, an array of micro-mirrors is formed using microelectromechanical manufacturing techniques and arrays of ports are coupled to that microelectromechanical mirror array. Regardless of the type of integration that might be effected if microelectromechanical techniques or other strategies are adopted, it is possible to build prototype systems out of readily available discrete optical components and suitable implementations of the present invention can be achieved using discrete, commercially available components.

FIG. 7 illustrates aspects of a 2×2′ switch in accordance with an embodiment of the present invention. The designation 2×2′ is used here to indicate that there is generally no connection between the add and drop channels in the pass through state of certain preferred implementations of the described add/drop module. The FIG. 7 switch is in an add/drop state that might be used to add a signal to an unused channel of an optical transmission line (add) such as when a transmitter at a first position generates a signal to be provided to a distant point. Alternately, the FIG. 7 configuration might be used to remove a signal from an optical fiber (drop), for example, so that the optical signal can be converted into an electrical signal and provided to a server, an electrical switch or a like computer device. In the FIG. 7 implementation, four ports 66, 68, 70 and 72 are provided in a plane so that a simple rotation or translation of the mirror 74 can move light from one port to another port. As illustrated in this example, the port 66 is associated with an add channel, the port 68 is associated with an input channel, the port 70 is associated with a drop channel and the port 72 is associated with an output channel. For purposes of this illustration, it is useful to consider the input and add ports to be collimated light sources that can selectively provide light carrying a signal, while the drop and output ports are broadband receivers. Note that, while the discussion here is in terms of the particularly preferred implementation where mirror rotation accomplishes changing states of the mirror, it is possible to achieve the same results through different, simple mechanical mechanisms.

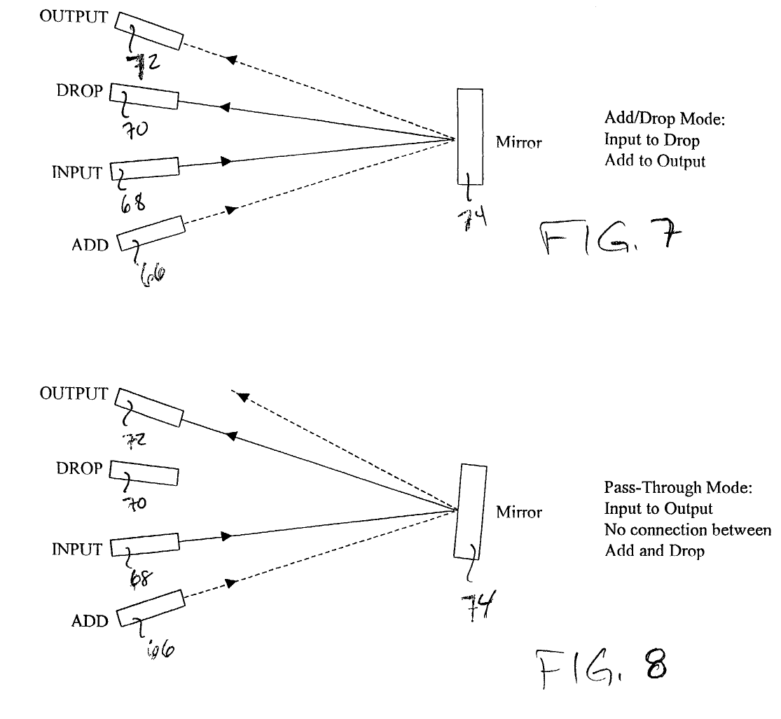

In the illustrated add/drop state, light provided through the input port 68 reflects off of the mirror 74 and is output through the drop port 70. Light provided through the add port 66 reflects off of the mirror 74 and is output through the output port. FIG. 8 shows the 2×2′ switch in a pass through state. The mirror 74 is rotated so that the light from the input port 68 is coupled to the output port 72. In this state, the add port preferably is positioned so that light from the add port is not coupled into the drop port or the output port. These two switching states can be selected fairly simply by positioning the ports with respect to the mirror using simple optical principals. The illustrated order of the ports is significant to operation of the switch, but other configurations do work such as an inversion of the illustrated order, that is, with the add port at the top and the input port as second from the top. Other orders for the ports are apparent. It is preferred that the input and add ports be grouped together and that the drop and output ports be grouped together on opposite sides of a normal to the front face of the mirror in the illustrated embodiment.

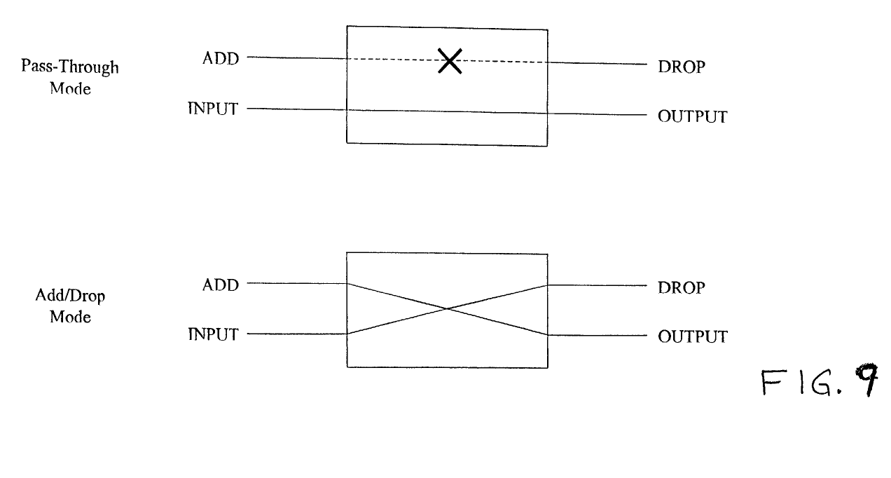

FIG. 9 shows schematically the input and output connections that are achieved using the switch of FIGS. 7 and 8. As shown, in the preferred pass through state, the add channel is not coupled to the drop channel and the input channel is coupled to the output channel. In the add/drop state, the add channel connects to the output channel and the input channel connects to the drop channel. Thus, the switch architecture illustrated in FIGS. 7 and 8 has the advantage of appropriate couplings without the undesirable add channel to drop channel coupling of the conventional add/drop modules and 2×2 switches described above in the Background.

While the present discussion is in terms of detecting signals that are dropped from a communication network, the drop channels might also be used to reroute signals. For example, a signal dropped at one add/drop module may be added at another add/drop module. Moreover, channels that are dropped are not always replaced and it is not always necessary to drop a channel before adding another channel. These considerations will depend greatly on the particular network and location in which the add/drop module is to be used.

Referring now to FIG. 10, a more detailed illustration of the 2×2′ switch is shown. This illustration is generally similar to that of FIGS. 7-8, in that ports 66, 68, 70 and 72 may correspond to add, input, drop and output ports respectively. Greater detail is shown for the various ports. For example, output port 72 includes an optical fiber that couples light out of the switch for the output channel. Light reflected from the mirror toward the output port travels over a free space path and then is received by a collimator 78 that couples light into a waveguide 80. The light propagates through the waveguide 80 and lens 82 couples the light from the waveguide 80 into the output optical fiber. Drop port 70 is constructed similarly and functions similarly. The add and input ports, 66 and 68 respectively, couple light from respective fibers through lenses 84, 86 into respective waveguides 88, 90. The add or input light propagates through the respective waveguides 88 or 90 to collimating optics 92 or 94 for output toward the mirror. As shown in FIG. 10 each of the add and input light signals propagates through a free space portion before reflecting from the mirror and into the receiving collimators of the drop or output channels.

As shown in FIG. 10, it is preferred that the collimating optics 78, 92, 94 and 96 are aligned with a substantially common reflection point on the face of the mirror 74. The fact that the light beams are substantially coincident makes the optical alignment particularly convenient, but this is not required to implement the switch. FIG. 10 shows a microelectromechanical (MEM) mirror array used for controlling the state of the switch. Such mirrors are known in the art and can be made to precise tolerances and to switch according to applied electrical signals. A MEM mirror is particularly preferred in that it can be made small and can be readily integrated with electrical circuits for control of the mirror position.

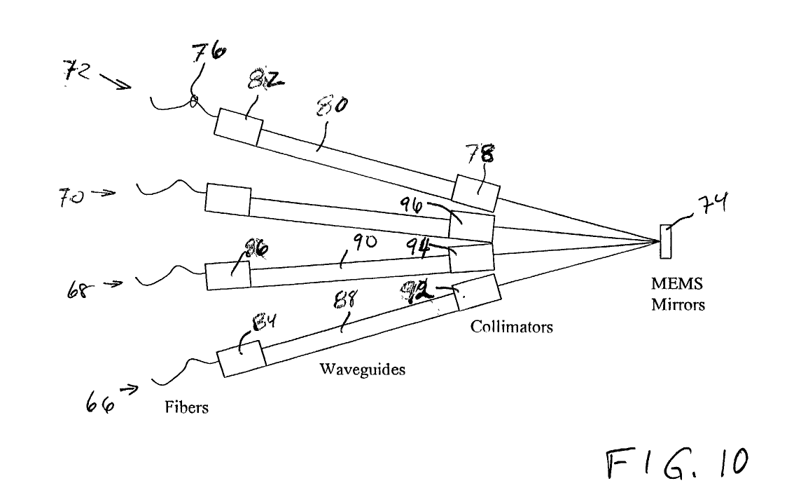

According to some embodiments, the MEM mirror may be provided with a normal position where the mirror remains unless moved to another position and a latch to hold the mirror in a second position until the latch is released. In this way, the switch of FIG. 10 has two positions that can be held in place without continuously supplied power or other signals. The normal and latched positions for the mirror corresponds to the add/drop state and the pass through state of the switch. In other implementations, optical detectors may be coupled to the drop and output channels. This can be accomplished in any of the known techniques. For example, the fiber may be mounted in a curved position so that slight leakage occurs, which leakage is coupled into a detector that is calibrated to provide a measure of the intensity of light within the fiber. In another implementation, a detector may be positioned to detect a portion of the light passing through the collimating lens. Alternately, the fiber may be coupled through an in-line detector that monitors optical power. A feedback loop couples the detector output to the mirror positioning circuit to allow the mirror to be held in an appropriate position under closed loop control. These positioning mechanisms are also desirable for the more integrated switch assembly of FIG. 11.

The fixed position mirror system is preferred for its simplicity, while the closed loop system is preferred because the levels of power output from the add/drop module can be controlled with precision. That is, when using the power detection for the drop and output channels and use closed loop control for mirror positioning in each channel, variable optical attenuation can be performed by aligning and misaligning the mirror to achieve desired levels of optical output. It is possible that either strategy might be preferred, depending on the particular application in which the optical add/drop module is used.

FIG. 11 shows an integration of eight channels of 2×2′ switches like that illustrated in FIG. 10. Eight fibers might be provided in a ribbon configuration for the eight channels, so that eight add fibers are provided in ribbon 100, eight input fibers are provided in ribbon 102, eight drop fibers are provided in ribbon 104 and eight output fibers are provided in ribbon 106. The add fiber array 100 is coupled through an array of coupling optics 108 into an array of channel waveguides 110. The dimensions of the waveguide are preferably chosen to achieve guiding and to efficiently couple the light from the optics 108 out through the corresponding array of collimating optics 112. The input port array is configured similarly, as are the drop port and output port arrays. An array 114 of MEM mirrors is provided, with each mirror independently controllable so that each mirror can be positioned to switch each channel between an add/drop state and a pass through state, as described above. Thus, FIG. 11 illustrates a highly integrated combination of eight 2×2′ switches.

In the FIG. 11 implementation and in the FIG. 13 implementation discussed below, it is not necessary to use the channel waveguides. Rather, individual fibers can be held in position within a V-groove to provide distinct waveguides.

Each of the mirrors of the linear array 114 of FIG. 11, in certain preferred embodiments, is preferably held in position through a detector and a closed loop control to achieve a desired level of power or attenuation in that particular channel. Alternately, each of the mirrors in the array might have defined first and second positions (defined by angle of rotation or equivalent means) that correspond to pass through and add/drop states. As discussed above, the choice to have variable attenuation and closed loop control versus the simplicity of the fixed position mirrors is one based on the particular network implementation. Specifically, low cost or particularly compact and simple implementations do not use closed loop control and instead define fixed positions for pass through and add/drop states. In other instances where signal quality and high data rates are important, the variable attenuation feature is used to maintain desired signal levels within the system.

The more typical configuration of the FIG. 11 array is for the input channels to receive a single fiber input and the illustrated planar channel waveguides to be replaced with an arrayed waveguide grating. Thus, the single input channel (102) would have a single channel input to an arrayed waveguide grating that separates the optical signal on the single input fiber into a total of eight channels. Similarly, the output channel more typically comprises an arrayed waveguide grating that receives up to eight channels and multiplexes those channels for output on a single fiber. Similar strategies can also be employed for the add and drop channels, but it is typically less desirable to do so.

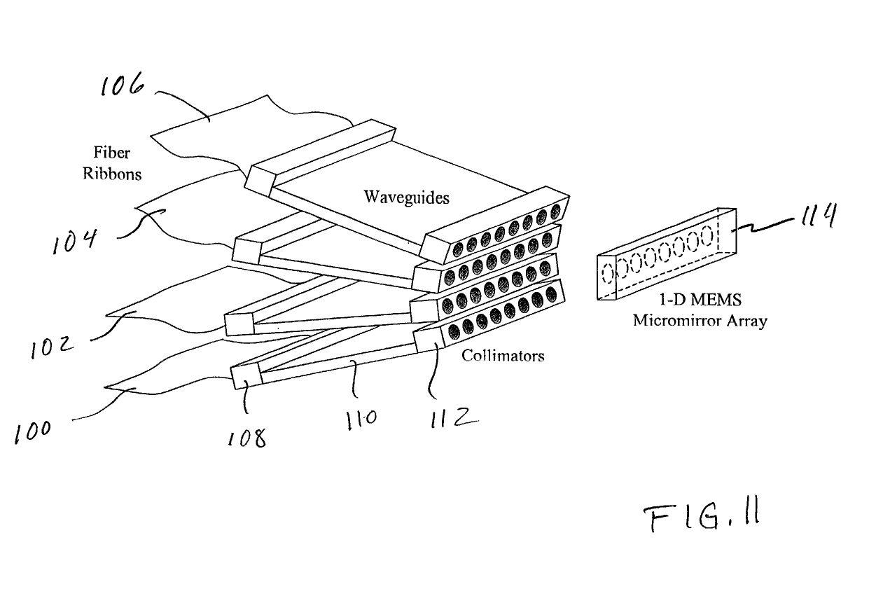

FIG. 12 illustrates schematically an aspect of the mirror assembly that might be used in a preferred implementation of the mirror array 114. Only a single one of the mirrors is shown. Generally all of the mirrors are formed on a common surface of a single crystal of silicon using microelectromechanical machining technology. More specifically, preferred implementations of the mirror array 114 are formed on a single crystal of silicon using the micromachining techniques described in U.S. Pat. No. 6,150,275, which patent is incorporated by reference in its entirety. Additional aspects of a preferred manufacturing process are described in pending U.S. patent application Ser. No. 09/771,169, filed Jan. 26, 2001 and entitled “Micro-Machined Silicon ON-OFF Fiber Optic Switching System,” which patent application is hereby incorporated by reference for all of its teachings on the manufacture of silicon microelectromechanical structures.

Referring now to FIG. 12, the mirror is formed on a silicon substrate 120 and provides in the illustrated example a generally rectangular planar silicon mirror surface 122. Generally a metal such as aluminum or gold is deposited to a desirable thickness on the face of the mirror to provide a high level of reflectivity. The mirror is separated from the silicon substrate on the backside so that the mirror surface is attached to the substrate only by hinges 124 on either side of the mirror. These hinges are simple silicon beams that provide a torsional restoring force and support for the mirror surface 122. These silicon beams define the rotational axis for this mirror. Most preferably, each of the eight mirrors of the illustrated array 114 has a rotational axis aligned with the other mirrors so that the eight rotational axes are collinear in three-dimensional space. More complicated hinges can be defined, generally for lower levels of restoring forces and greater levels of rotational movement. For such more complicated hinges, the rotational axes of the individual mirrors are still preferably aligned for the simplicity such alignment brings to assembly of the rest of the add/drop module.

The mirror surface 122 preferably is separated from the underlying silicon substrate 120 by a substantial separation to allow considerable rotational movement to the mirror. Movement is accomplished by providing appropriate DC signals to the appropriate comb electrodes 126, 128 on either end of the mirror surface 122. The comb electrodes are shown in greatly simplified form in this illustration, but are a familiar structure in the MEM art. To effect rotation of the mirror face, the comb electrodes of the substrate are generally offset lower than the corresponding portion of the comb electrodes of the mirror surface, although such a configuration is not always necessary. Opposite polarity charging arrangements, i.e., repelling charges on one set of comb electrodes and attracting charges on the other set of comb electrodes, may be used to apply greater force. As mentioned the single mirror of FIG. 12 is one of an array of eight collinear mirrors used in the array 114 shown in FIG. 11.

FIG. 13 illustrates a further integration of a switch assembly based on the switch assembly of FIGS. 7 and 8. N channels of light are provided on a fiber 136 to a demultiplexer 138 to separate the N channels of light, on N different wavelengths into N different signal channels. The demultiplexer 138 can be an array waveguide grating of the known type. Each of the N signal channels is provided as an input channel to a 2×2′ switch 140 like that illustrated in FIGS. 7-8 or 10 above. Each of the N signal channels can be dropped and replaced with a signal input from the add channels 142. The dropped channels 144 can be rerouted to other optical fibers or can be provided to detectors or other electrical circuitry. Alternately, the switches 140 can independently pass through each of the signal channels. The passed through signals and the added signals that make up the N signal channels after the switches 140 are provided into a multiplexer 146. The multiplexer 146 may be an array waveguide of the known type and recombines the separate signal channels into a transmission fiber 148. The portions of the FIG. 13 switch assembly between the demultiplexer 138 and the multiplexer 146 could be configured like the array of 2×2′ switches illustrated in FIG. 11.

In general the optical switches described here route optical signals modulated with high amounts of information. As the terms are described here, the terms optical and light are intended broadly. Optical communications networks conventionally operate most efficiently with light in the near to mid infrared range.

Although the present invention has been described in detail with reference only to the presently preferred embodiments, those of ordinary skill in the art will appreciate that various modifications can be made without departing from the invention. Accordingly, the invention is not to be limited to any of the described embodiments thereof but is instead defined by the following claims.

What is claimed:

1. An optical system, comprising:
a switching mirror defining a first switch state and a second switch state;
an input port positioned to provide input light to the switching mirror;
an add port positioned to provide add light to the switching mirror;
an output port, the output port positioned to receive the input light from the switching mirror in the first switch state and to receive the add light from the switching mirror in the second switch state; and
a drop port, the drop port positioned to receive the input light from the switching mirror in the second switch state.

2. The optical system of claim 1, wherein the switching mirror rotates from a first angular position to a second angular position to switch from the first switch state to the second switch state.

3. The optical system of claim 1, wherein light directed from the add port is not incident on the drop port in the first switch state.

4. The optical system of claim 3, wherein in the first switch state the switching mirror is in a first angular position and in the second switch state the switching mirror is in a second angular position.

5. The optical system of claim 1, wherein the input port includes entrance optics coupled to a waveguide and a collimator coupled to the waveguide and providing input light to the switching mirror.

6. The optical system of claim 5, wherein the entrance optics receive light from an optical fiber.

7. The optical system of claim 5, wherein the output port couples light from the switching mirror into a waveguide.

8. The optical system of claim 5, wherein the output port couples light from the switching mirror into a waveguide, through exit optics and into an optical fiber.

9. The optical system of claim 7, wherein in the first switch state the mirror is in a first angular position and in the second switch state the mirror is in a second angular position.

10. The optical system of claim 8, wherein the drop port couples light from the switching mirror into a waveguide, through exit optics and into an optical fiber.

11. The optical system of claim 10, wherein the switching mirror rotates from a first angular position to a second angular position to switch from the first switch state to the second switch state.

12. The optical system of claim 11, wherein light directed from the add port is not incident on the drop port in the first switch state.

13. The optical system of claim 10, wherein the drop port receives light from the switching mirror through a collimator and the collimator provides the light into the waveguide.

14. An optical system, comprising:
an array of switching mirrors including a first switching mirror defining a first switch state and a second switch state;
a first input port positioned to provide first input light to the first switching mirror;
a first add port positioned to provide first add light to the first switching mirror;
a first output port, the first output port positioned to receive the first input light from the first switching mirror in the first switch state and to receive the first add light from the first switching mirror in the second switch state; and
a first drop port, the first drop port positioned to receive the first input light from the first switching mirror in the second switch state.

15. The optical system of claim 14, wherein the array of switching mirrors includes a second switching mirror defining a first switch state and a second switch state, the optical system further comprising:
a second input port positioned to provide second input light to the second switching mirror;
a second add port positioned to provide second add light to the second switching mirror;
a second output port, the second output port positioned to receive the second input light from the second switching mirror in the first switch state and to receive the second add light from the second switching mirror in the second switch state; and
a second drop port, the second drop port positioned to receive the second input light from the second switching mirror in the second switch state.

16. The optical system of claim 15, wherein the first switching mirror rotates from a first angular position to a second angular position to switch from the first switch state to the second switch state, and
wherein the second switching mirror rotates from a first angular position to a second angular position to switch from the first switch state to the second switch state, the first switching mirror rotating independently from the second switching mirror.

17. The optical system of claim 15, wherein light directed from the first add port is not incident on the first drop port in the first switch state of the first switching mirror.

18. The optical system of claim 15, wherein in the first switch state the first switching mirror is in a first angular position and in the second switch state the first switching mirror is in a second angular position.

19. The optical system of claim 1, wherein the first and second input ports include entrance optics coupled to an array of channel waveguides and collimators coupled to the array of channel waveguides and providing first and second input light to the first and second switching mirrors.

20. An optical system, comprising:
an array of independent switching mirrors, each of the switching mirrors defining a first switch state and a second switch state;
an array of input ports each positioned to provide input light to a respective one of the switching mirrors;
an array of add ports each positioned to provide add light to a respective one of the switching mirrors;
an array of output ports, each of the array of output ports associated with a respective switching mirror and positioned to receive the input light from the respective switching mirror in the first switch state and to receive the add light from the respective switching mirror in the second switch state; and
an array of drop ports, each of the drop ports associated with a respective switching mirror and positioned to receive the input light from the switching mirror in the second switch state.

21. The optical system of claim 20, wherein the array of switching mirrors is linear, the array of input ports is linear, the array of add ports is linear, the array of output ports is linear and the array of drop ports is linear.

22. The optical system of claim 21, wherein light directed from any of the add ports is not incident on its respective drop port in the first switch state of its respective switching mirror.

23. The optical system of claim 20, wherein the array of input ports comprises a first array of channel waveguides, the array of add ports comprises a second array of channel waveguides, the array of output ports comprises a third array of channel waveguides and the array of drop ports comprises a fourth array of channel waveguides.

24. The optical system of claim 20, wherein the array of input ports is immediately adjacent the array of input ports and the array of output ports is immediately adjacent the array of drop ports.

25. The optical system of claim 24, wherein the array of input ports is adjacent the array of drop ports.

26. The optical system of claim 24, wherein the array of input ports is between the array of add ports and the array of drop ports.

27. The optical system of claim 24, wherein the array of drop ports is between the array of output ports and the array of input ports.

28. The optical system of claim 20, further comprising a demultiplexer coupled to an input fiber, the demultiplexer separating input light into N channels of light corresponding to N input ports of the array of input ports.

29. The optical system of claim 20, further comprising a multiplexer coupled to the array of output ports, the multiplexer combining channels of light from the array of output ports and providing output light to an output fiber.

30. The optical system of claim 20, further comprising:
a demultiplexer coupled to an input fiber, the demultiplexer separating input light into N channels of light corresponding to N input ports of the array of input ports; and
a multiplexer coupled to the array of output ports, the multiplexer combining channels of light from the array of output ports and providing output light to an output fiber.

31. The optical system of claim 30, wherein the demultiplexer and the multiplexer are arrayed waveguide gratings.
